(19) United States
(12) Patent Application Publication
(10) Pub. No.: US 2014/0263726 A1
(43) Pub. Date: Sep. 18, 2014

(54) LOW RESONANCE SYNTHETIC JET STRUCTURE

(71) Applicant: General Electric Company, Schenectady, NY (US)

(72) Inventors: Hendrik Pieter Jacobus de Bock, Clifton Park, NY (US); Bryan Patrick Whalen, Gansevoort, NY (US)

(73) Assignee: General Electric Company, Schenectady, NY (US)

(21) Appl. No.: 14/205,926

(22) Filed: Mar. 12, 2014

Related U.S. Application Data
(60) Provisional application No. 61/784,648, filed on Mar. 14, 2013.

(51) Int. Cl. B05B 17/06

(52) U.S. Cl. CPC B05B 17/0615
USPC 239/102.2; 29/890.09

(57) ABSTRACT

A system and method for achieving lower acoustic output and increased flow output in a synthetic jet device is disclosed. A synthetic jet sub-assembly includes a mounting bracket comprising a top surface and a bottom surface, a first flexible substrate positioned across an opening defined by the mounting bracket and attached to the top surface of the mounting bracket, a second flexible substrate positioned across the opening defined by the mounting bracket and attached to the bottom surface of the mounting bracket, a first plate affixed to an outward facing surface of the first flexible substrate and a second plate affixed to an outward facing surface of the second flexible substrate.

### CROSS-REFERENCE TO RELATED APPLICATION

The present application is a non-provisional of, and claims priority to, U.S. Provisional Patent Application Ser. No. 61/784,648, filed Mar. 14, 2013, the disclosure of which is incorporated herein by reference.

### BACKGROUND OF THE INVENTION

Synthetic jet actuators are a widely-used technology that generates a synthetic jet of fluid to influence the flow of that fluid over a surface to disperse heat away therefrom. A typical synthetic jet actuator comprises a housing defining an internal chamber. An orifice is present in a wall of the housing. The actuator further includes a mechanism in or about the housing for periodically changing the volume within the internal chamber so that a series of fluid vortices are generated and projected in an external environment out from the orifice of the housing. Examples of volume changing mechanisms may include, for example, a piston positioned in the jet housing to move fluid in and out of the orifice during reciprocation of the piston or a flexible diaphragm as a wall of the housing. The flexible diaphragm is typically actuated by a piezoelectric actuator or other appropriate means.

Typically, a control system is used to create time-harmonic motion of the volume changing mechanism. As the mechanism decreases the chamber volume, fluid is ejected from the chamber through the orifice. As the fluid passes through the orifice, sharp edges of the orifice separate the flow to create vortex sheets that roll up into vortices. These vortices move away from the edges of the orifice under their own self-induced velocity. As the mechanism increases the chamber volume, ambient fluid is drawn into the chamber from large distances from the orifice. Since the vortices have already moved away from the edges of the orifice, they are not affected by the ambient fluid entering into the chamber. As the vortices travel away from the orifice, they synthesize a jet of fluid, i.e., a “synthetic jet.”

A drawback of existing synthetic jet designs is the noise generated from operation of the synthetic jet. Audible noise is inherent in the operation of synthetic jets as a result of the flexible diaphragm being caused to deflect in an alternating motion, and the natural frequencies of the synthetic jet's various operational modes (structural/mechanical, disk-bending, and acoustic) impact the amount of noise generated during operation. In operation, synthetic jets are typically excited at or near a mechanical resonance mode in order to optimize electrical to mechanical conversion and so as to achieve maximum deflection at minimal mechanical energy input. While synthetic jet cooling performance is optimized when operated at or near a mechanical resonance mode, it is recognized that operating the synthetic jet at certain frequencies can generate a substantial amount of acoustic noise, with such noise having a structural natural frequency at a level of 600 Hz for example, as the acoustic signature of the device is in part determined by the drive frequency of the device.

It would therefore be desirable to provide a synthetic jet that is capable of operating at a mechanical resonance mode that has a low resonance frequency (e.g., less than 500 Hz), so as to reduce the apparent acoustic noise generated by the synthetic jet while not affecting the flow output of the device.

### BRIEF DESCRIPTION OF THE INVENTION

According to one aspect of the invention, a synthetic jet sub-assembly comprises a mounting bracket comprising a top surface and a bottom surface, a first flexible substrate positioned across an opening defined by the mounting bracket and attached to the top surface of the mounting bracket, a second flexible substrate positioned across the opening defined by the mounting bracket and attached to the bottom surface of the mounting bracket, a first plate affixed to an outward facing surface of the first flexible substrate and a second plate affixed to an outward facing surface of the second flexible substrate.

In accordance with another aspect of the invention, a method of manufacturing a synthetic jet assembly includes providing a mounting bracket that defines an opening and affixing a pair of flexible substrates to the mounting bracket on opposing top and bottom surfaces thereof such that each of the pair of flexible substrates spans over the opening of the mounting bracket, with the pair of flexible substrates and the mounting bracket defining a cavity. The method also includes attaching a first plate to an outward facing surface of one of the pair of flexible substrates, attaching a second plate to an outward facing surface of the other of the flexible substrates, and attaching an actuator element to at least one of the first and second plates to selectively cause deflection thereof, thereby changing a volume within the cavity so that a flow of fluid is generated and projected out from the cavity.

In accordance with yet another aspect of the invention, a synthetic jet assembly includes a mounting bracket comprising a plurality of legs defining an opening and a synthetic jet positioned at least partially within the opening of the mounting bracket, with the synthetic jet further including a first flexible substrate stretched across the opening defined by the mounting bracket and attached to a top surface of the mounting bracket and a second flexible substrate stretched across the opening defined by the mounting bracket and attached to a bottom surface of the mounting bracket, with the first and second flexible substrates and the mounting bracket define a synthetic jet cavity in fluid communication with a surrounding environment. The synthetic jet also includes a first plate affixed to an outward facing surface of the first flexible substrate, a second plate affixed to an outward facing surface of the second flexible substrate, and an actuator element coupled to at least one of the first and second plates to selectively cause deflection thereof such that a fluid flow is generated and projected out from the synthetic jet cavity. The first and second flexible substrates secure the synthetic jet to the mounting bracket.

In accordance with still another aspect of the invention, a synthetic jet sub-assembly includes a mounting bracket comprising a top surface and a bottom surface, a first flexible substrate positioned across an opening defined by the mounting bracket and attached to the top surface of the mounting bracket, a second flexible substrate positioned across the opening defined by the mounting bracket and attached to the bottom surface of the mounting bracket, and a plate affixed to an outward facing surface of at least one of the first and second flexible substrates.

These and other advantages and features will be more readily understood from the following detailed description of preferred embodiments of the invention that is provided in connection with the accompanying drawings.

### BRIEF DESCRIPTION OF THE DRAWINGS

The drawings illustrate embodiments presently contemplated for carrying out the invention.

In the drawings:

FIGS. 1 and 2 are views of a synthetic jet assembly useable with embodiments of the invention.

FIG. 3 is a cross-section of the synthetic jet of FIGS. 1 and 2 depicting the jet as the control system causes the diaphragms to travel inward, toward the orifice.

FIG. 4 is a cross-section of the synthetic jet of FIGS. 1 and 2 depicting the jet as the control system causes the diaphragms to travel outward, away from the orifice.

FIGS. 5 and 6 are top and side cross-sectional views of a synthetic jet assembly, according to an embodiment of the invention.

FIG. 7 is a top view of a synthetic jet assembly, according to an embodiment of the invention.

FIG. 8 is a top view of a synthetic jet assembly, according to an embodiment of the invention.

### DESCRIPTION OF THE INVENTION

Embodiments of the invention are directed to an apparatus and method for achieving lower acoustic output and increased flow output in a synthetic jet device.

FIGS. 1-4 illustrate a general structure of a synthetic jet assembly 10 and the movement of various components during operation thereof, for purposes of better understanding the invention. Referring first to FIG. 1, the synthetic jet assembly 10 is shown as including a synthetic jet 12, a cross-section of which is illustrated in FIG. 2, and a mounting bracket 14. In one embodiment, mounting bracket 14 is a u-shaped mounting bracket that is affixed to a body or housing 16 of synthetic jet 12 at one or more locations, although it is recognized that the mounting bracket may be constructed as a bracket having a different shape/profile, such as a semi-circular bracket configured to receive a circular synthetic jet 12 therein. A circuit driver 18 can be externally located or affixed to mounting bracket 14. Alternatively, circuit driver 18 may be remotely located from synthetic jet assembly 10.

Referring now to FIGS. 1 and 2 together, and as shown therein, housing 16 of synthetic jet 12 defines and partially encloses an internal chamber or cavity 20 having a gas or fluid 22 therein. While housing 16 and internal chamber 20 can take virtually any geometric configuration according to various embodiments of the invention, for purposes of discussion and understanding, housing 16 is shown in cross-section in FIG. 2 as including a first plate 24 and a second plate 26 (or shims), which are maintained in a spaced apart relationship by a spacer element 28 positioned therebetween. In one embodiment, spacer element 28 maintains a separation of approximately 1 mm between first and second plates 24, 26. One or more orifices 30 are formed between first and second plates 24, 26 and the side walls of spacer element 28 in order to place the internal chamber 20 in fluid communication with a surrounding, exterior environment 32. In an alternative embodiment, spacer element 28 includes a front surface (not shown) in which one or more orifices 30 are formed.

According to various embodiments, first and second plates 24, 26 may be formed from a metal, plastic, glass, and/or ceramic. Likewise, spacer element 28 may be formed from a metal, plastic, glass, and/or ceramic. Suitable metals include materials such as nickel, aluminum, copper, and molybdenum, or alloys such as stainless steel, brass, bronze, and the like. Suitable polymers and plastics include thermoplastics such as polyolefins, polycarbonate, thermosets, epoxies, urethanes, acrylics, silicones, polyimides, and photoresist-capable materials, and other resilient plastics. Suitable ceramics include, for example, titanates (such as lanthanum titanate, bismuth titanate, and lead zirconate titanate) and molybdates. Furthermore, various other components of synthetic jet 12 may be formed from metal as well.

Actuators 34, 36 are coupled to respective first and second plates, 24, 26 to form first and second composite structures or flexible diaphragms 38, 40, which are controlled by driver 18 via a controller assembly or control unit system 42. For example, each flexible diaphragm 38, 40 may be equipped with a metal layer and a metal electrode may be disposed adjacent to the metal layer so that diaphragms 38, 40 may be moved via an electrical bias imposed between the electrode and the metal layer. As shown in FIG. 1, in one embodiment controller assembly 42 is electronically coupled to driver 18, which is coupled directly to mounting bracket 14 of synthetic jet 12. In an alternative embodiment control unit system 42 is integrated into a driver 18 that is remotely located from synthetic jet 12. Moreover, control system 42 may be configured to generate the electrical bias by any suitable device, such as, for example, a computer, logic processor, or signal generator.

In one embodiment, actuators 34, 36 are piezoelectric motive (piezomotive) devices that may be actuated by application of a harmonic alternating voltage that causes the piezomotive devices to rapidly expand and contract. During operation, control system 42 transmits an electric charge, via driver 18, to piezoelectric actuators 34, 36, which undergo mechanical stress and/or strain responsive to the charge. The stress/strain of piezomotive actuators 34, 36 causes deflection of respective first and second plates 24, 26 such that a time-harmonic or periodic motion is achieved that changes the volume of the internal chamber 20 between plates 24, 26. According to one embodiment, spacer element 28 can also be made flexible and deform to change the volume of internal chamber 20. The resulting volume change in internal chamber 20 causes an interchange of gas or other fluid between internal chamber 20 and exterior volume 32, as described in detail with respect to FIGS. 3 and 4.

Piezomotive actuators 34, 36 may be monomorph or bimorph devices, according to various embodiments of the invention. In a monomorph embodiment, piezomotive actuators 34, 36 may be coupled to plates 24, 26 formed from materials including metal, plastic, glass, or ceramic. In a bimorph embodiment, one or both piezomotive actuators 34, 36 may be bimorph actuators coupled to plates 24, 26 formed from piezoelectric materials. In an alternate embodiment, the bimorph may include single actuators 34, 36, and plates 24, 26 are the second actuators.

The components of synthetic jet 12 may be adhered together or otherwise attached to one another using adhesives, solders, and the like. In one embodiment, a thermoset adhesive or an electrically conductive adhesive is employed to bond actuators 34, 36 to first and second plates, 24, 26 to form first and second composite structures 38, 40. In the case of an electrically conductive adhesive, an adhesive may be filled with an electrically conductive filler such as silver, gold, and the like, in order to attach lead wires (not shown) to synthetic jet 12. Suitable adhesives may have a hardness in the range of Shore A hardness of 100 or less and may include as examples silicones, polyurethanes, thermoplastic rubbers, and the like, such that an operating temperature of 120 degrees or greater may be achieved.

In an embodiment of the invention, actuators 34, 36 may include devices other than piezoelectric motive devices, such as hydraulic, pneumatic, magnetic, electrostatic, and ultrasonic materials. Thus, in such embodiments, control system 42 is configured to activate respective actuators 34, 36 in corresponding fashion. For example, if electrostatic materials are used, control system 42 may be configured to provide a rapidly alternating electrostatic voltage to actuators 34, 36 in order to activate and flex respective first and second plates 24, 26.

The operation of synthetic jet 12 is described with reference to FIGS. 3 and 4. Referring first to FIG. 3, synthetic jet 12 is illustrated as actuators 34, 36 are controlled to cause first and second plates 24, 26 to move outward with respect to internal chamber 20, as depicted by arrows 44. As first and second plates 24, 26 flex outward, the internal volume of internal chamber 20 increases, and ambient fluid or gas 46 rushes into internal chamber 20 as depicted by the set of arrows 48. Actuators 34, 36 are controlled by control system 42 so that when first and second plates 24, 26 move outward from internal chamber 20, vortices are already removed from edges of orifice 30 and thus are not affected by the ambient fluid 46 being drawn into internal chamber 20. Meanwhile, a jet of ambient fluid 46 is synthesized by vortices creating strong entrainment of ambient fluid 46 drawn from large distances away from orifice 30.

FIG. 4 depicts synthetic jet 12 as actuators 34, 36 are controlled to cause first and second plates 24, 26 to flex inward into internal chamber 20, as depicted by arrows 50. The internal volume of internal chamber 20 decreases, and fluid 22 is ejected as a cooling jet through orifice 30 in the direction indicated by the set of arrows 52 toward a device 54 to be cooled, such as, for example a light emitting diode. As the fluid 22 exits internal chamber 20 through orifice 30, the flow separates at the sharp edges of orifice 30 and creates vortex sheets which roll into vortices and begin to move away from edges of orifice 30.

While the synthetic jet of FIGS. 1-4 is shown and described as having a single orifice therein, it is also envisioned that embodiments of the invention may include multiple orifice synthetic jet actuators. Additionally, while the synthetic jet actuators of FIGS. 1-4 are shown and described as having an actuator element included on each of first and second plates, it is also envisioned that embodiments of the invention may include only a single actuator element positioned on one of the plates. Furthermore, it is also envisioned that the synthetic jet plates may be provided in a circular, rectangular, or alternatively shaped configuration, rather than in a square configuration as illustrated herein.

Referring now to FIGS. 5 and 6, top and side views are provided of a synthetic jet assembly 60 that is constructed to achieve lower apparent acoustic output and increased flow output, according to an embodiment of the invention. The general structure of the synthetic jet assembly 60 is similar to that shown in FIGS. 1-4 (with like parts being numbered the same) as the assembly includes a synthetic jet 62 positioned within a mounting bracket 14 that, according to an exemplary embodiment, is constructed as a u-shaped mounting bracket. However, in the synthetic jet of FIG. 5, the synthetic jet 62 is formed to have a different structure than the synthetic jet 12 of FIG. 1, and the synthetic jet 62 is affixed to the mounting bracket 14 in a different fashion than that shown in FIG. 1 so as to allow the synthetic jet 62 to achieve lower apparent acoustic output and increased flow output. The term “apparent acoustic output” is used herein to indicate that while the actual noise level generated by the synthetic jet 62 may or may not be reduced, the mechanical or structural resonance of the synthetic jet 62 might be altered to a lower resonance frequency such that the synthetic jet generates noise at frequencies below 500 Hz—which is a frequency level/range in which human hearing is less sensitive—so that the a noise level at this lower frequency will appear lower than the same noise level at a higher frequency (e.g., 600 Hz).

In the synthetic jet assembly 60, synthetic jet is 62 constructed to include a first plate 24 and a second plate 26 formed from a suitable material (e.g., metal, plastic, glass, and/or ceramic). Actuators 34, 36 are coupled to respective first and second plates, 24, 26. A harmonic alternating voltage may be applied to piezoelectric actuators 34, 36 (such as from a driver 18 via a controller assembly or control unit system 42, as shown/described in FIG. 1) to create a mechanical stress therein that causes deflection of respective first and second plates 24, 26 such that a time-harmonic or periodic motion is achieved that changes the volume of an internal chamber 64 between plates 24, 26.

Also forming part of the synthetic jet are flexible substrates or plates 66 that are stretched and spanned over the u-shaped bracket 14 on each of a top and bottom surface 68, 70 of the bracket 14. According to an exemplary embodiment, the flexible substrates 66 are formed of biaxially-oriented polyethylene terephthalate (boPET)—or more generally known as mylar—or are formed alternatively of urethane. It is recognized, however, that other similar and suitable materials having a similar level of flexibility could be used to form the substrates 66. In forming the synthetic jet 62, the first and second plates, 24, 26 (and actuators 34, 36 positioned thereon) are attached to the top and bottom flexible substrates 66, an outward facing surfaces 72 of the substrates 66. According to one embodiment, a glue or adhesive (not shown) is used to secure the first and second plates, 24, 26 to the flexible substrates 66. As the flexible substrates 66 are spaced apart due to their placement/adhesion on opposing top and bottom surfaces 68, 70 of the u-shaped bracket 14, the flexible substrates 66 and the u-shaped bracket 14 collectively form the cavity 64 in the synthetic jet 62. The cavity 64 includes an opening 76 (similar to the opening/orifice shown in FIG. 1) in order to place the cavity 64 in fluid communication with a surrounding, exterior environment 32.

In addition to forming part of the synthetic jet 62, the flexible substrates 66 also function to mount the synthetic jet 62 relative to the u-shaped mounting bracket 14. The flexible substrates 66 are secured to each of a rear leg 76 and side legs 78, 80 of the u-shaped bracket 14 using glue or another suitable adhesive, generally indicated at 82, and thus secure the synthetic jet 62 to the u-shaped mounting bracket 14.

As best seen in FIG. 5, according to one embodiment of the invention, a pair of hinges 84 is added in the back of the synthetic jet 62 to further connect the first and second plates 24, 26 to the u-shaped bracket 14. The hinges 84 may be formed from one of a number of materials, and may be provided in the form of a layer of glue or silicone or a metal strip. The hinges 84 function as an additional mechanism for maintaining the synthetic jet 62 in position relative to the u-shaped mounting bracket 14. While the synthetic jet assembly 60 is shown in FIG. 5 as including a pair of hinges 84 positioned on the back edge of the synthetic jet 62, it is recognized that other synthetic jet assemblies might be formed having only a single hinge 84 (FIG. 7) or no hinges (FIG. 8).

In operation of the synthetic jet assembly 60, the actuators 34, 36 can be actuated to cause a deflection of the first and second plates 24, 26 and flexible substrates 66 and thereby change a volume of the cavity 64 in the synthetic jet 62, as can best be seen in FIG. 6—with deflection of the plates and substrate being indicated by the dashed lines 84. Once the synthetic jet 62 is actuated, the synthetic jet 62 can operate in a very low resonance mode and provide a maximum amplitude over the full width of the synthetic jet. That is, as the substrate layers 66 (of mylar or urethane, for example) used to form the synthetic jet 62 and secure it to the u-shaped mounting bracket 14 are very flexible, they allow for the synthetic jet 62 to have a different modal shape during operation (i.e., the modal shape of the moving plates 24, 26). The substrate layers 66 and the modal shape allowed for thereby enable the synthetic jet 62 to operate in a very low resonance mode and provide a maximum amplitude over the full width of the synthetic jet (i.e., full width of the opening/orifice between the two plates) that is utilized for flow production.

It is recognized that synthetic jet assemblies 10 that employ flexible substrates 66 for affixing the synthetic jet 12 to a mounting bracket 14 are not limited to structures that include square/rectangular synthetic jets 12 and a u-shaped mounting bracket 14, such as are shown in FIGS. 5-8. That is, synthetic jet assemblies 10 having other shapes and configurations are also envisioned as falling within the scope of the invention. For example, a synthetic jet assembly 10 that includes a circular synthetic jet and a semi-circular mounting bracket that employs flexible substrates for affixing the synthetic jet to the mounting bracket is considered to be within the scope of the invention.

Beneficially, embodiments of the invention thus provide a synthetic jet assembly 60 including flexible substrates 66 that enable operation of the synthetic jet 62 in and at a mechanical resonance mode that has a low resonance frequency (e.g., less than 500 Hz). Operation of the synthetic jet 62 in this mechanical resonance mode reduces the apparent acoustic noise generated by the synthetic jet while not affecting the flow output of the device, as the synthetic jet 62 is still able to operate at a maximum amplitude over the full width of the synthetic jet. Additionally, the synthetic jet 62 can be selectively “tuned” to perform at higher acoustic levels and varied flow output.

Therefore, according to one embodiment of the invention, a synthetic jet sub-assembly comprises a mounting bracket comprising a top surface and a bottom surface, a first flexible substrate positioned across an opening defined by the mounting bracket and attached to the top surface of the mounting bracket, a second flexible substrate positioned across the opening defined by the mounting bracket and attached to the bottom surface of the mounting bracket, a first plate affixed to an outward facing surface of the first flexible substrate and a second plate affixed to an outward facing surface of the second flexible substrate.

According to another aspect of the invention, a method of manufacturing a synthetic jet assembly includes providing a mounting bracket that defines an opening and affixing a pair of flexible substrates to the mounting bracket on opposing top and bottom surfaces thereof such that each of the pair of flexible substrates spans over the opening of the mounting bracket, with the pair of flexible substrates and the mounting bracket defining a cavity. The method also includes attaching a first plate to an outward facing surface of one of the pair of flexible substrates, attaching a second plate to an outward facing surface of the other of the flexible substrates, and attaching an actuator element to at least one of the first and second plates to selectively cause deflection thereof, thereby changing a volume within the cavity so that a flow of fluid is generated and projected out from the cavity.

According to yet another aspect of the invention, a synthetic jet assembly includes a mounting bracket comprising a plurality of legs defining an opening and a synthetic jet positioned at least partially within the opening of the mounting bracket, with the synthetic jet further including a first flexible substrate stretched across the opening defined by the mounting bracket and attached to a top surface of the mounting bracket and a second flexible substrate stretched across the opening defined by the mounting bracket and attached to a bottom surface of the mounting bracket, with the first and second flexible substrates and the mounting bracket define a synthetic jet cavity in fluid communication with a surrounding environment. The synthetic jet also includes a first plate affixed to an outward facing surface of the first flexible substrate, a second plate affixed to an outward facing surface of the second flexible substrate, and an actuator element coupled to at least one of the first and second plates to selectively cause deflection thereof such that a fluid flow is generated and projected out from the synthetic jet cavity. The first and second flexible substrates secure the synthetic jet to the mounting bracket.

According to still another aspect of the invention, a synthetic jet sub-assembly includes a mounting bracket comprising a top surface and a bottom surface, a first flexible substrate positioned across an opening defined by the mounting bracket and attached to the top surface of the mounting bracket, a second flexible substrate positioned across the opening defined by the mounting bracket and attached to the bottom surface of the mounting bracket, and a plate affixed to an outward facing surface of at least one of the first and second flexible substrates.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A synthetic jet sub-assembly comprising:
a mounting bracket comprising a top surface and a bottom surface;
a first flexible substrate positioned across an opening defined by the mounting bracket and attached to the top surface of the mounting bracket;
a second flexible substrate positioned across the opening defined by the mounting bracket and attached to the bottom surface of the mounting bracket;
a first plate affixed to an outward facing surface of the first flexible substrate and; and
a second plate affixed to an outward facing surface of the second flexible substrate.

2. The synthetic jet sub-assembly of claim 1 wherein the first and second flexible substrates and the mounting bracket define a cavity in fluid communication with a surrounding environment.

3. The synthetic jet sub-assembly of claim 2 wherein the synthetic jet assembly further comprises an actuator element coupled to at least one of the first and second plates to selectively cause deflection thereof, thereby changing a volume within the cavity so that a flow of fluid is generated and projected out therefrom.

4. The synthetic jet sub-assembly of claim 1 further comprising one or more hinges attached to a back edge of at least one of the first and second plates so as to couple the back edge of the at least one of the first and second plates to the mounting bracket.

5. The synthetic jet sub-assembly of claim 4 wherein the one or more hinges comprises a pair of hinges attached to the back edge of the at least one of the first and second plates.

6. The synthetic jet sub-assembly of claim 4 wherein the one or more hinges comprises a single hinge attached to the back edge of the at least one of the first and second plates.

7. The synthetic jet sub-assembly of claim 4 wherein each of the one or more hinges comprises a layer of glue or silicone.

8. The synthetic jet sub-assembly of claim 4 wherein each of the one or more hinges comprises a metal strip.

9. The synthetic jet sub-assembly of claim 1 wherein the first and second flexible substrate affect a modal shape of the first and second plates, so as to reduce an apparent level of acoustic noise generated by the synthetic jet assembly during operation thereof.

10. The synthetic jet sub-assembly of claim 1 wherein each of the first and second flexible substrates comprises mylar or urethane.

11. The synthetic jet sub-assembly of claim 1 wherein the mounting bracket comprises a u-shaped bracket.

12. A method of manufacturing a synthetic jet assembly comprising:
providing a mounting bracket that defines an opening;
affixing a pair of flexible substrates to the mounting bracket on opposing top and bottom surfaces thereof such that each of the pair of flexible substrates spans over the opening of the mounting bracket, with the pair of flexible substrates and the mounting bracket defining a cavity;
attaching a first plate to an outward facing surface of one of the pair of flexible substrates;
attaching a second plate to an outward facing surface of the other of the flexible substrates; and
attaching an actuator element to at least one of the first and second plates to selectively cause deflection thereof, thereby changing a volume within the cavity so that a flow of fluid is generated and projected out from the cavity.

13. The method of claim 12 further comprising forming one or more hinges on a back edge of each of the first and second plates, each of the one or more hinges extending between the mounting bracket and the back edge of each of the first and second plates to mechanically couple the first and second plates to the mounting bracket.

14. The method of claim 13 wherein forming the one or more hinges comprises one of applying a layer of glue, applying a layer of silicone, or applying a metal strip.

15. The method of claim 12 wherein each of the first and second flexible substrates comprises mylar or urethane.

16. A synthetic jet assembly comprising:
a mounting bracket comprising a plurality of legs defining an opening; and
a synthetic jet positioned at least partially within the opening of the mounting bracket, the synthetic jet comprising:
a first flexible substrate stretched across the opening defined by the mounting bracket and attached to a top surface of the mounting bracket;
a second flexible substrate stretched across the opening defined by the mounting bracket and attached to a bottom surface of the mounting bracket, with the first and second flexible substrates and the mounting bracket define a synthetic jet cavity in fluid communication with a surrounding environment;
a first plate affixed to an outward facing surface of the first flexible substrate;
a second plate affixed to an outward facing surface of the second flexible substrate; and
an actuator element coupled to at least one of the first and second plates to selectively cause deflection thereof such that a fluid flow is generated and projected out from the synthetic jet cavity;
wherein the first and second flexible substrates secure the synthetic jet to the mounting bracket.

17. The synthetic jet assembly of claim 16 further comprising one or more hinges attached to a back edge of at least one of the first and second plates so as to couple the back edge of the at least one of the first and second plates to the mounting bracket.

18. The synthetic jet assembly of claim 16 wherein the first and second flexible substrate affect a modal shape of the first and second plates, so as to reduce an apparent level of acoustic noise generated by the synthetic jet assembly during operation thereof.

19. The synthetic jet assembly of claim 16 wherein each of the first and second flexible substrates comprises mylar or urethane.

20. A synthetic jet sub-assembly comprising:
a mounting bracket comprising a top surface and a bottom surface;
a first flexible substrate positioned across an opening defined by the mounting bracket and attached to the top surface of the mounting bracket;
a second flexible substrate positioned across the opening defined by the mounting bracket and attached to the bottom surface of the mounting bracket;
a plate affixed to an outward facing surface of at least one of the first and second flexible substrates.
